(19) United States
(12) Patent Application Publication
(10) Pub. No.: US 2018/0113748 A1
(43) Pub. Date: Apr. 26, 2018

(54) AUTOMATED CONFIGURATION OF VIRTUAL INFRASTRUCTURE

(71) Applicant: Hewlett Packard Enterprise Development LP, Houston, TX (US)

(72) Inventor: Ganesh Ashok Pagade, Bangalore (IN)

(21) Appl. No.: 15/614,862

(22) Filed: Jun. 6, 2017

(30) Foreign Application Priority Data
Oct. 21, 2016 (IN) 201641036165

(51) Int. Cl. G06F 9/50; G06F 9/455; H04L 29/08

(52) U.S. Cl. CPC G06F 9/5077; G06F 9/45558; G06F 2009/45562; H04L 67/10; H04L 67/1095

(57) ABSTRACT

Automated configuration of virtual infrastructure is disclosed. One example is a system including at least one processor and a memory storing instructions to monitor resource utilizations of a plurality of deployed instances in a virtual infrastructure, receive a request to deploy another instance based on a pre-configured template with a configured resource allocation, where the template is common to a sub-plurality of the plurality of deployed instances, and determine a configuration error based on differences between recommended resource utilizations, based on the monitored resource utilizations, of each of the sub-plurality of deployed instances and the configured resource allocation. Upon a determination that the configuration error exceeds the threshold, instructions are provided to automatically adjust the configured resource allocation of the template based on the recommended resource utilizations of the sub-plurality of deployed instances, and instructions to deploy the another instance based on the template with the adjusted resource allocation.

### BACKGROUND

Virtual infrastructure is generally configured and deployed based on resource allocations that are determined at the time of deployment. Such resource allocations are determined based on existing templates. Resource utilization may be monitored and the allocated resources may be adjusted.

### BRIEF DESCRIPTION OF THE DRAWINGS

FIG. 1 is a functional block diagram illustrating one example of a system for automated configuration of virtual infrastructure.

FIG. 2 is a functional block diagram illustrating another example of a system for automated configuration of virtual infrastructure.

FIG. 3 is a flow diagram illustrating one example of a method for automated configuration of virtual infrastructure.

FIG. 4 is a block diagram illustrating one example of a computer readable medium for automated configuration of virtual infrastructure.

### DETAILED DESCRIPTION

Cloud service providers generally provide a suite of offerings to facilitate private and/or hybrid cloud implementations. The offerings may include automated service lifecycle management, comprehensive unified service management, open and extensible architecture, and platforms and capabilities for Infrastructure-as-a-Service (“IaaS”) and Platform-as-a-Service (“PaaS”). Such offerings may include an array of features, including provisioning and monitoring of infrastructure, deployment and scaling for private and hybrid clouds, and capacity management.

As applications and workloads move to hybrid cloud environments, ensuring computing service capacity and performance becomes a significant factor. However, these hybrid environments are of a dynamic nature, making resolution of capacity and performance issues somewhat complex. A proper allocation of resources can significantly impact performance.

For example, a proper allocation of resources for virtual machines may help balance resource utilization and capacity planning across a virtualized environment. Proper placement and optimization of cloud resource functionality may include providing suggestions about where new virtual machines may be provisioned in the virtualized environment, as well as how the environment may be optimized and sized correctly based on historical resource usage trends and available capacity.

In many instances, cloud optimization tools provide access to resource usage forecast analyses, and the tools may forecast capacity by logical organizational groups (such as departments, sales organizations, or production teams) within an organization. In some examples, the tools may facilitate planning for the future with capacity prediction functionality and short- and long-term projections of capacity threshold breaches. System administrators may then correct deployed applications and services based on the monitored data, thereby providing a level of dynamic control over the deployed infrastructure.

Current virtual infrastructure sizing recommendations made by such tools are generally based on the resource utilization of each deployed instance under consideration. For example, based on monitored data, the number of virtual central processing units (“vCPUs”) of a virtual machine (“VM”) may be reduced from 4 to 2. Although such recommended resource utilizations are helpful to infrastructure administrators for resizing the deployed instances, such corrective measures may not address the root cause for such sizing discrepancies. Generally, this results from a lack of corrective action being taken on the content used to provision such instances.

For example, infrastructure administrators may rely on preconfigured contents like VM Templates, Blue Prints and/or Service Offerings that are built on top of the VM Templates to respond to similar kinds of provision requests. As such, if a service offering is based on a common template, then recommending resizing of the individual components of the service offering does not identify and/or correct the discrepancies in the underlying template. Accordingly, deployment managers would continue to provision the incorrectly sized instances. Also, for example, administrators with different roles may not be able to establish a correlation between the deployed content and the instances that are identified to have resource utilizations that differ from the deployed configuration. In some instances, the infrastructure administrators may not have access to data that may establish such correlations. A continued use of incorrectly configured content may lead to repeating the sizing mistakes, thereby resulting in suboptimal utilization of datacenter resources.

Accordingly, there is a need to identify resource utilization errors, and provide corrective measures that may be applied to underlying configuration content so as to correctly provision future resource requests. As described in various examples herein, automated configuration of virtual infrastructure is disclosed. One example is a system including at least one processor and a memory storing instructions executable by the at least one processor to monitor resource utilizations of a plurality of deployed instances in a virtual infrastructure, receive a request to deploy another instance based on a pre-configured template with a configured resource allocation, where the template is common to a sub-plurality of the plurality of deployed instances, and determine a configuration error based on differences between recommended resource utilizations, based on the monitored resource utilizations, of each of the sub-plurality of deployed instances and the configured resource allocation. Upon a determination that the configuration error exceeds the threshold, instructions are provided to automatically adjust the configured resource allocation of the template based on the recommended resource utilizations of the sub-plurality of deployed instances, and instructions to deploy the another instance based on the template with the adjusted resource allocation.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

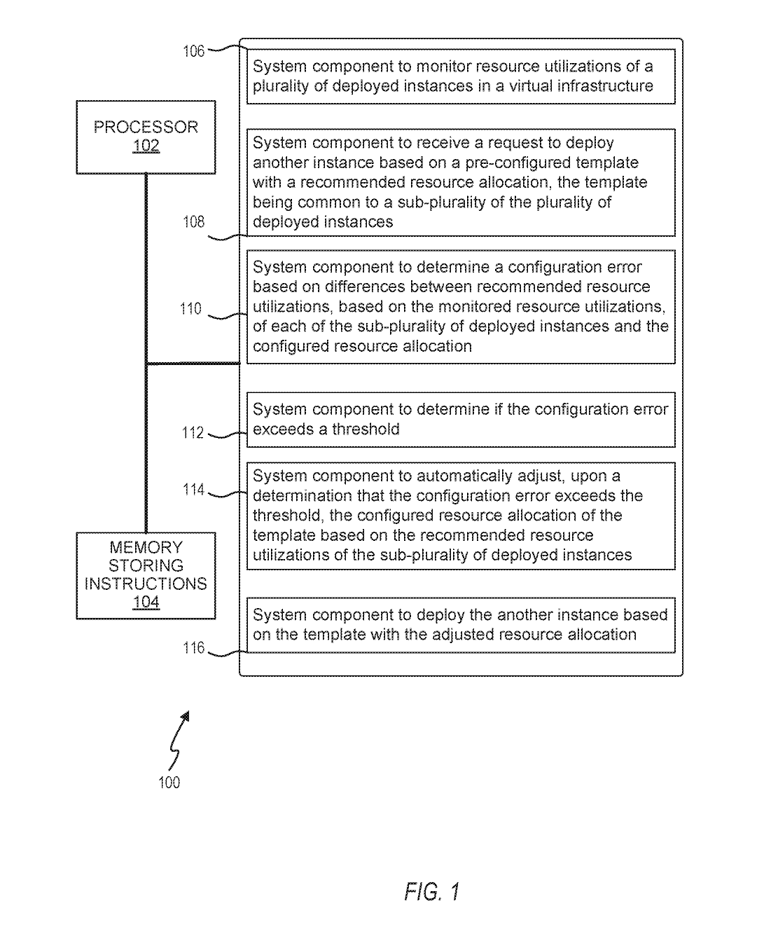

FIG. 1 is a functional block diagram illustrating one example of a system 100 for system for automated configuration of virtual infrastructure. System 100 is shown to include a processor 102, and a memory 104 storing instructions to enable a plurality of system components 106-116 to perform various functions of the system.

The term “system” may be used to refer to a single computing device or multiple computing devices that communicate with each other (e.g. via a network) and operate together to provide a unified service. In some examples, the components of system 100 may communicate with one another over a network. As described herein, the network may be any wired or wireless network, including a network of cloud computing resources, and may include any number of hubs, routers, switches, cell towers, and so forth. Such a network may be, for example, part of a cellular network, part of the Internet, part of an intranet, and/or any other type of network.

Memory 104 may store instructions for a system component 106 to monitor resource utilizations of a plurality of deployed instances in a virtual infrastructure. A virtual infrastructure may be a collection of virtual resources providing infrastructure to support services and/or applications. The virtual resources may be collections of instances of services and/or applications that are deployed via the virtual infrastructure. For example, an array of virtual machines may be deployed to provide a service. A deployed instance, as used herein, is any virtual resource that may be deployed in the virtual infrastructure. In some examples, the plurality of deployed instances in the virtual infrastructure may comprise a plurality of deployed virtual machines, a plurality of applications deployed on a virtual machine, a plurality of service offerings based on a template for a virtual machine, or a plurality of blue prints. Generally, a blue print may be a pre-configured platform for various resource offerings. Generally, any such deployed instance includes content that may be included in a pre-configured template. The term “content” as used herein may generally refer to any configuration for the instance. The terms “content” and “resource allocation” may be used interchangeably, and the context may generally clarify the intended meaning.

In some examples, the resource utilizations may include a number of virtual central processing units (vCPUs) that are being utilized by the deployed instances, a size of dynamic memory allocated to the deployed instances, a size for memory at start up time, a minimum memory value, a maximum memory value, a disk space allocation, and a time delay to run an automatic start. For example, the deployed instances may be a plurality of virtual machines, and the resource utilizations may be a number of vCPUs assigned to the deployed virtual machines, a size of dynamic memory allocated to the deployed virtual machines, a size for memory when the virtual machines start up, a minimum memory value for respective virtual machines, a maximum memory value for respective virtual machines, a disk space allocation for respective virtual machines, and a time delay to run an automatic start for each virtual machine.

In many examples, instances are deployed using pre-configured templates. For example, a template for a virtual machine may be pre-configured with various resource allocations for a number of vCPUs, memory sizes, and the like. However, when the virtual machine is actually deployed in a virtual infrastructure, the actual resource utilization of the deployed instance may be different from the resource allocation provisioned in the pre-configured template.

As described herein, various monitoring tools may be available to obtain data on resource utilization in the virtual infrastructure. For example, smart detailed alerts may be available to enable detection of performance anomalies such as bottlenecks and resource saturation, determine symptom causes, and address such performance anomalies before performance deteriorates. For example, monitoring tools may be available to provide system administrators a performance capacity utilization view of subscribed cloud services. For individual deployed instances, the system administrator may release unused resources and thereby reduce costs. Also, for example, for individual deployed instances, the system administrator may receive performance metrics or related analytics to be able to plan for future capacity requirements. Generally, resource utilization data may be generated and received, and provisioned resource allocations may be appropriately adjusted on a case by case basis.

Memory 104 may store instructions for a system component 108 to receive a request to deploy another instance based on a pre-configured template with a configured resource allocation, the template being common to a sub-plurality of the plurality of deployed instances. As described herein, instances may be deployed based on pre-configured templates. Generally, these templates include configured resource allocations for the instance. In some examples, the resource allocations may include a number of virtual central processing units (vCPUs) that are being utilized by the requested instance, a size of dynamic memory allocated to the requested instance, a size for memory at start up time, a minimum memory value, a maximum memory value, a disk space allocation, and a time delay to run an automatic start. For example, the requested instance may be a plurality of virtual machines, and the resource allocations may be a number of vCPUs assigned to the requested virtual machines, a size of dynamic memory allocated to the requested virtual machines, a size for memory when the virtual machines start up, a minimum memory value for respective requested virtual machines, a maximum memory value for respective requested virtual machines, a disk space allocation for respective requested virtual machines, and a time delay to run an automatic start for each requested virtual machine.

Also, as described herein, even though deployed instances may be configured based on monitored metrics, so that resources may be re-configured based on actual utilization, existing technologies are not equipped to identify and/or address an underlying root cause for such deviations in utilization. For example, a virtual machine may be deployed based on a pre-configured template that allocates four vCPUs. However, based on monitored data, it may be determined, post-deployment, that two vCPUs are being utilized. Accordingly, a system administrator may be provided instructions with a recommendation to reduce the allocated four vCPUs to two vCPUs. However, when a new virtual machine is requested for deployment, the existing pre-configured template is used again thereby allocating four vCPUs to the new virtual machine, in contrast with the recommended resource utilization of two vCPUs. Such continued use of incorrect allocation of resources may result in suboptimal utilization of datacenter resources. In some examples, repeated provisioning of undersized and/or oversized VMs may lead to substantial application performance degradation. Also, for example, administrators may spend more time taking corrective measures such as implementing and/or acknowledging recommendations and/or alerts that are generated by monitoring devices.

In some examples, the instructions to receive the request to deploy another instance may include instructions to cluster the plurality of deployed instances, where two deployed instances belong to the same cluster if they are based on a shared template, and instructions to associate each cluster with the shared template. For example, as instances are deployed, an association between the deployed instance and the underlying template used to configure the deployed instance may be maintained in a database. As a result, deployed instances may be grouped or formed into clusters based on common, shared, underlying templates. Such an association between a deployed instance and a template aids in automatically re-configuring underlying templates so as to optimize future resource allocation.

Accordingly, in some examples, the instructions to receive the request to deploy another instance may include instructions to identify the sub-plurality of deployed instances by identifying the cluster associated with the pre-configured template. For example, when a request for a new instance is processed by system 100, a pre-configured template may be identified, and the sub-plurality of deployed instances may be identified, for example via the database associations, by identifying the deployed instances associated with the pre-configured template for the requested new instance.

Memory 104 may store instructions for a system component 110 to determine a configuration error based on differences between the recommended resource utilizations of each of the sub-plurality of deployed instances and the configured resource allocation. The term “configuration error” as used herein generally refers to a difference between a resource allocation for an instance to be deployed based on a template, and a recommended resource utilization of an already deployed instance based on the same underlying template. For example, three VMs may be deployed, each based on a template configuration that allocates four vCPUs to each VM. However, monitored metrics may indicate that based on performance characteristics of the infrastructure, the actual recommended resource utilization of the three VMs is two vCPUs each. When a new VM is requested based on the same underlying template that allocates four vCPUs to each VM, a configuration error of 2 vCPUs may be determined.

In some examples, the instructions to determine the configuration error may include instructions to determine an average of ratios of the differences between the recommended resource utilizations of each of the deployed instances and the configured resource allocation. For example, three VMs may be deployed, each based on a template configuration that allocates four vCPUs to each VM. However, monitored metrics may indicate that based on performance characteristics of the infrastructure, the actual recommended resource utilization of the three VMs is 2, 2, and 3 vCPUs each. When a new VM is requested based on the same underlying template that allocates four vCPUs to each VM, a configuration error may be determined based on the average of ratios of the differences between the recommended resource utilizations of each of the deployed instances and the configured resource allocation. In this example, the differences may be determined as 4−2=2 for the first two deployed VMs, and 4−3=1 for the third deployed VM. Accordingly, a ratio of the differences to the recommended resource utilization may be determined as 2/2, 2/2 and 1/3. In some examples, an average of these ratios may be determined as 1/3 of 7/3, which is 7/9, or 77.78%.

For example, n VMs may be deployed based on an existing pre-configured template, and F may a configured resource allocation for a resource in the template. However, the recommended resource utilization of the resource in the deployed template may be Aₜ, where t=1, . . . , n, for each deployed VM. Absolute differences between the recommended resource utilizations of each of the deployed instances and the configured resource allocation of the template may be determined as |Aₜ−F| for each t=1, . . . , n. Also, for example, a ratio of these absolute differences |Aₜ−F| to the recommended resource utilization Aₜ may be determined as

$$\vert \frac{{A}_{t} - F}{{A}_{t}} \vert \qquad ( Eqn . 1 )$$

In some examples, a configuration error, M, may be determined as an average of the expressions in Eq. 1. For example, M may be determined as a mean absolute error:

$$M = \frac{1}{n} {\sum }_{t = 1}^{n} \vert \frac{{A}_{t} - F}{{A}_{t}} \vert \qquad ( Eqn . 2 )$$

In some examples, M may be determined as a weighted average. For example, weights w₁, w₂, . . . , wₙ may be associated with each deployed instance. Such weights may be associated, in one example, based on a confidence level of the recommended resource utilization. Generally, the configuration error, M, may be determined as a weighted average:

$$M = \frac{1}{n} {\sum }_{t = 1}^{n} {w}_{t} \vert \frac{{A}_{t} - F}{{A}_{t}} \vert \qquad ( Eqn . 3 )$$

In some examples, the determined value of the configuration error may be multiplied by 100 to provide the configuration error as a mean absolute percentage error. Although the mean has been utilized as a statistic to determine the configuration error, other measures of deviation from a normal may be utilized as well.

Memory 104 may store instructions for a system component 112 to determine if the configuration error exceeds a threshold. For example, a threshold of 10% may be utilized, and the system 100 may determine if the configuration error exceeds 10%. Accordingly, memory 104 may store instructions for a system component 114 to automatically adjust the configured resource allocation of the template based on the recommended resource utilizations of the sub-plurality of deployed instances. For example, if three VMs are deployed based on a template that allocates 4 vCPUs to each deployed VM, and it is determined that the respective recommended resource utilization is 2, 2, and 3, then the system 100 may determine the mean absolute percentage error to be 77.78%, which is greater than 10%.

Upon a determination that the configuration error exceeds the threshold, memory 104 may store instructions for a system component 116 to automatically adjust the configured resource allocation of the template based on the recommended resource utilizations of the sub-plurality of deployed instances. In some examples, the adjusted configurations may be saved into the template by overwriting the prior configurations in the pre-configured template. Accordingly, any subsequent requests for an instance may utilize the adjusted configurations of the underlying template and may therefore not have error greater than the threshold.

In some examples, the instructions to automatically adjust the configured resource allocation may include instructions to determine the configured resource allocation as an average of the recommended resource utilizations of the sub-plurality of deployed instances:

$$Adjusted Resource Allocation = \frac{1}{n} {\sum }_{t = 1}^{n} {A}_{t} \qquad ( Eqn . 4 )$$

In some examples, the instructions to automatically adjust the configured resource allocation may include instructions to determine the configured resource allocation as a weighted average of the recommended resource utilizations of the sub-plurality of deployed instances. Here, associated weights wₜ′ may be the same or at least one may be different from the weights wₜ that were used in the determination of the configuration error:

$$Adjusted Resource Allocation = \frac{1}{n} {\sum }_{t = 1}^{n} {w}_{t}^{′} {A}_{t} \qquad ( Eqn . 5 )$$

In some examples, the configuration error may be determined to be less than the threshold. For illustrative purposes, three VMs may be deployed based on a template that allocates 4 vCPUs to each deployed VM. It may be determined that the respective recommended resource utilization is 8, 8, and 7. In this example, the differences may be determined as 8−8=0 for the first two deployed VMs, and 8−7=1 for the third deployed VM. Accordingly, a ratio of the differences to the recommended resource utilization may be determined as 0/8, 0/8 and 1/7. In some examples, an average of these ratios may be determined as 1/3 of 1/7, which is 1/21. Accordingly, the system 100 may determine the mean absolute percentage error to be or 4.76%, which does not exceed the threshold, 10%. Accordingly, upon a determination that the configuration error does not exceed the threshold, the instructions to automatically adjust the configured resource allocation may include instructions to automatically determine that the other instance is to be based on the pre-configured template with the configured resource allocation. According it may be determined that the resource allocation for the new requested UM may be configured resource allocation of four vCPUs.

Memory 104 may store instructions for a system component to re-configure the template for the new requested instance with the adjusted resource allocation. In some examples, memory 104 may store instructions for a system component 116 to deploy the other instance based on the template with the adjusted resource allocation. For example, upon a determination that the configuration error exceeds the threshold, the new requested instance may be deployed with the adjusted resource allocation, as for example, computed using Eq. 4 or Eqn. 5. Also, for example, upon a determination that the configuration error does not exceed the threshold, the new requested instance may be deployed with the configured resource allocation of the pre-configured template.

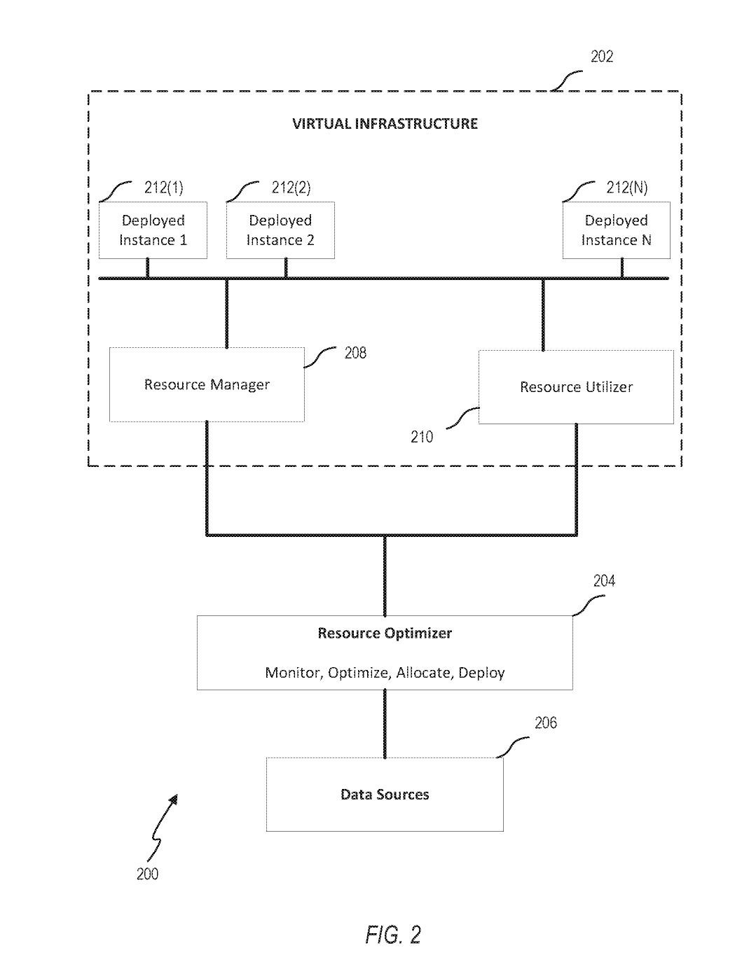

FIG. 2 is a functional block diagram illustrating another example of a system 200 for automated configuration of virtual infrastructure 202. System 200 described with reference to FIG. 2 may share some aspects of system 100 as described with reference to FIG. 1.

As illustrated, a virtual infrastructure 202 may be a collection of virtual resources providing infrastructure to support services and/or applications. The virtual resources may be collections of instances of services and/or applications (e.g., Deployed Instance 1 212(1), Deployed Instance 2 212(2), Deployed Instance N 212(N)), that are deployed via the virtual infrastructure 202. For example, an array of virtual machines may be deployed to provide a service.

In some examples, system 200 may include a system component to monitor resource utilizations of the plurality of deployed instances (e.g., Deployed Instance 1 212(1), Deployed Instance 2 212(2), . . . , Deployed Instance N 212(N)) in the virtual infrastructure 202. For example, resource utilizations may be monitored by the system component Resource Utilizer 210. Modifications to deployed resources may be made via the system component Resource Manager 208. For example, based on the monitored resource utilizations provided by the system component Resource Utilizer 210, the system component Resource Manager 208 may provide recommended resource utilizations. For example, three VMs may be deployed, each based on a template configuration that allocates four vCPUs to each VM. However, monitored metrics provided by the system component Resource Utilizer 210 may indicate that based on performance characteristics of the virtual infrastructure 202, the actual recommended resource utilization of the three VMs is two vCPUs each. The system component Resource Manager 208 may alter the resource utilization of the deployed VMs to the recommended resource utilization of two vCPUs each from the original configuration of 4 vCPUs each.

The resource optimizer 204 may be a system component that monitors, allocates, optimizes, and/or deploys the resources in the virtual infrastructure 202. The resource optimizer 204 may be viewed as an intelligent component that optimizes resource usage based on dynamic changes in the system environment, and anticipates resource needs based on forecasting abilities. For example, the resource optimizer 204 may determine a configuration error, compare the configuration error to a threshold, and determine an action based on whether the configuration error exceeds or does not exceed the threshold. The resource optimizer 204 may communicate with Resource Utilizer 210 to monitor the functioning of the virtual infrastructure 202, and may communicate with Resource Manager 208 to allocate, optimize, and/or deploy the resources in the virtual infrastructure 202. In some examples, resource optimizer 204 may communicate with Data Sources 206 to retrieve a pre-configured template. In some examples, resource optimizer 204 may communicate with Data Sources 206 to retrieve an association between an underlying template and a deployed instance.

In some examples, resource optimizer 204 may receive a request to deploy another instance based on a pre-configured template with a configured resource allocation, the template being common to a sub-plurality of the plurality of deployed instances (e.g., Deployed Instance 1 212(1), Deployed Instance 2 212(2), Deployed Instance N 212(N)). For example, the pre-configured template may be common to Deployed Instance 1 212(1), Deployed Instance 2 212(2), and Deployed Instance 3 212(3). The resource optimizer 204 may retrieve the template from Data Sources 206, and determine a configuration error based on differences between recommended resource utilizations, based on the resource utilizations monitored by Resource Utilizer 210, of each of the sub-plurality of deployed instances (e.g., Deployed Instance 1 212(1), Deployed Instance 2 212(2), and Deployed Instance 3 212(3)), and the configured resource allocation.

In some examples, the resource optimizer 204 may determine if the configuration error exceeds a threshold, and upon a determination that the configuration error exceeds the threshold, the resource optimizer 204 may automatically adjust the configured resource allocation of the template based on the recommended resource utilizations of the sub-plurality of deployed instances. In some examples, the resource optimizer 204 may prompt Resource Manager 208 to deploy the other instance based on the template with the adjusted resource allocation.

The components of system 100 or system 200 may be computing resources, each including a suitable combination of a physical computing device, a virtual computing device, a network, software, a cloud infrastructure, a hybrid cloud infrastructure that may include a first cloud infrastructure and a second cloud infrastructure that is different from the first cloud infrastructure, and so forth. The components of the system may be a combination of hardware and programming for performing designated functions. In some instances, each component may include a processor and a memory, while programming code is stored on that memory and executable by a processor to perform a designated function.

For example, Data Sources 206 may be a combination of hardware and programming for performing a designated function. For example, Data Sources 206 may include programming to store associations between templates and instances. Also, for example, Data Sources 206 may include hardware to physically store the templates, and processors to physically process the templates and configure instances. Also, for example, Data Sources 206 may include software programming to dynamically interact with the other components of system 100 or system 200.

Also, for example, resource optimizer 204 may be a combination of hardware and programming for performing a designated function. For example, resource optimizer 204 may include programming to communicate with Resource Utilizer 210 to monitor the functioning of the virtual infrastructure 202, and may include programming to communicate with Resource Manager 208 to allocate, optimize, and/or deploy the resources in the virtual infrastructure 202. Also, for example, resource optimizer 204 may include hardware to physically compute the configuration error, the threshold, and so forth. Also, for example, resource optimizer 204 may include software programming to dynamically interact with the other components of system 100 or system 200.

Likewise, Resource Manager 208 and Resource Utilizer 210 may include hardware to monitor and/or re-configure resource utilizations. System components may include input devices (e.g., to receive a user input threshold), and output devices (e.g., to provide visualization of resource utilization data).

Generally, the components of system 100 or system 200 may include programming and/or physical networks to be communicatively linked to other components of each respective system. In some instances, the components of each system may include a processor and a memory, while programming code is stored and on that memory and executable by a processor to perform designated functions.

Generally, the system components may be communicatively linked to computing devices. A computing device, as used herein, may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to perform a unified visualization interface. The computing device may include a processor and a computer-readable storage medium.

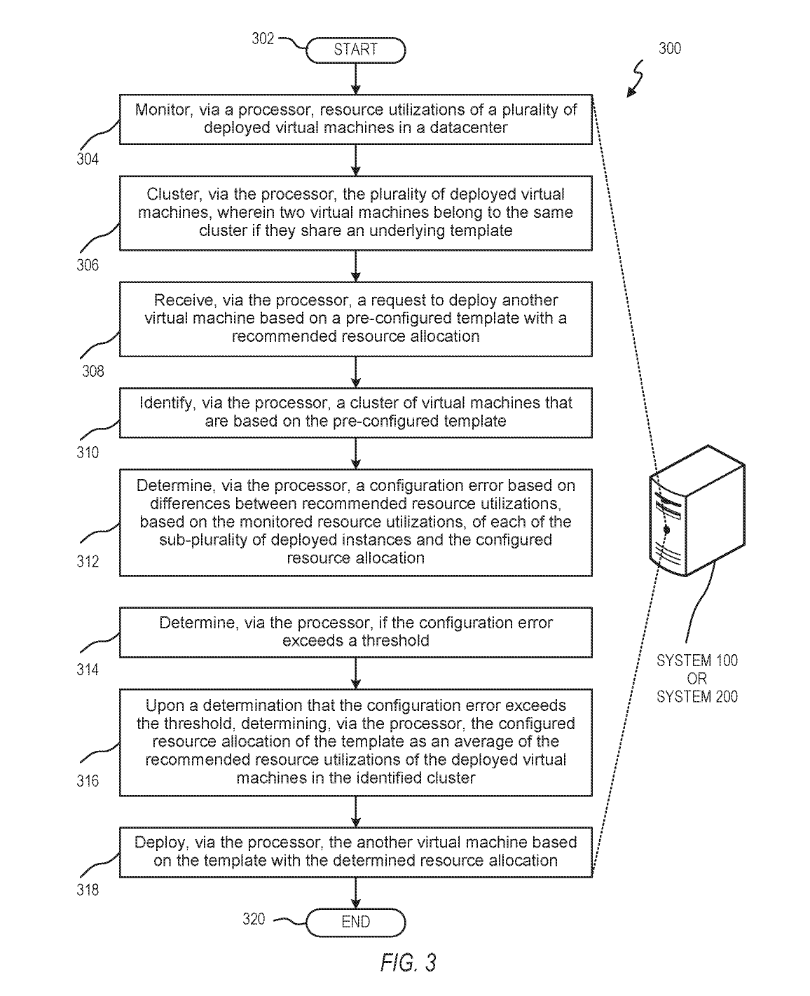

FIG. 3 is a flow diagram illustrating one example of a method for identifying candidate target storage containers. In some examples, such an example method may be implemented by a system such as, for example, system 100 of FIG. 1, and/or system 200 of FIG. 2. The method 300 may begin at block 302, and continue to end at block 320.

At 304, resource utilizations of a plurality of deployed virtual machines in a datacenter may be monitored via a processor.

At 306, the plurality of deployed virtual machines may be clustered, where two virtual machines belong to the same cluster if they share an underlying template.

At 308, a request may be received to deploy another virtual machine based on a pre-configured template with a configured resource allocation.

At 310, a cluster of virtual machines that are based on the pre-configured template may be identified via the processor.

At 312, a configuration error may be determined, where the configuration error is based on differences between recommended resource utilizations, based on the monitored resource utilizations, of each of the sub-plurality of deployed instances and the configured resource allocation.

At 314, it may be determined if the configuration error exceeds a threshold.

At 316, upon a determination that the configuration error exceeds the threshold, the configured resource allocation of the template may be determined as an average of the recommended resource utilizations of the deployed virtual machines in the identified cluster.

At 318, the other virtual machine based on the template with the determined resource allocation may be deployed via the processor.

As described herein, in some examples, the method may include determining the configuration error as a weighted average of ratios of the differences between the recommended resource utilizations of each of the deployed instances and the configured resource allocation.

In some examples, the method may include automatically deploying, upon a determination that the configuration error does not exceed the threshold, the other virtual machine based on the pre-configured template with the configured resource allocation.

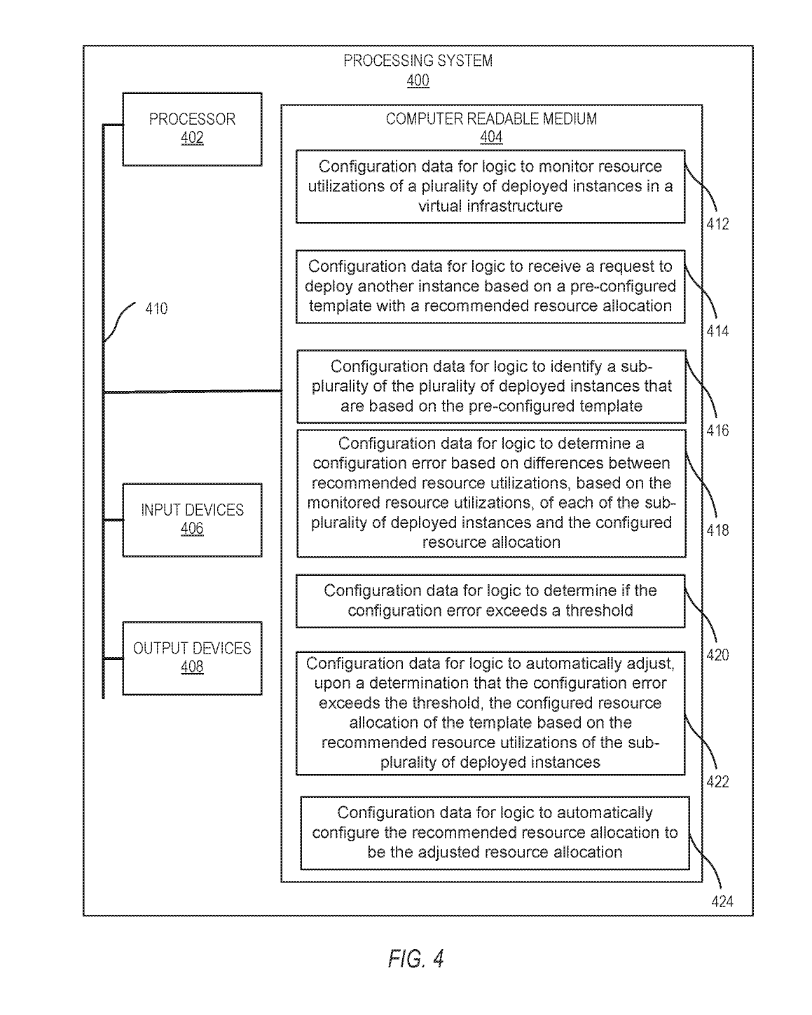

FIG. 4 is a block diagram illustrating one example of a computer readable medium for automated configuration of virtual infrastructure. Processing system 400 includes a processor 402, a computer readable medium 404, input devices 406, and output devices 408. Processor 402, computer readable medium 404, input devices 406, and output devices 408 are coupled to each other through a communication link (e.g., a bus) 410. In some examples, the non-transitory, computer readable medium 404 may store configuration data for the logic to perform the various functions of the processor 402.

Processor 402 executes instructions included in the computer readable medium 404 that stores configuration data for logic to perform the various functions. Computer readable medium 404 stores configuration data for logic 412 to monitor resource utilizations of a plurality of deployed instances in a virtual infrastructure.

Computer readable medium 404 stores configuration data for logic 414 to receive a request to deploy another instance based on a pre-configured template with a configured resource allocation.

Computer readable medium 404 stores configuration data for logic 416 to identify a sub-plurality of the plurality of deployed instances that are based on the pre-configured template.

Computer readable medium 404 stores configuration data for logic 418 to determine a configuration error based on differences between recommended resource utilizations, based on the monitored resource utilizations, of each of the sub-plurality of deployed instances and the configured resource allocation.

Computer readable medium 404 stores configuration data for logic 420 to determine if the configuration error exceeds a threshold.

Computer readable medium 404 stores configuration data for logic 422 to automatically adjust, upon a determination that the configuration error exceeds the threshold, the configured resource allocation of the template based on the recommended resource utilizations of the sub-plurality of deployed instances.

Computer readable medium 404 stores configuration data for logic 424 to automatically configure the configured resource allocation to be the adjusted resource allocation.

In some examples, computer readable medium 404 includes instructions to cluster the plurality of deployed instances, where two deployed instances belong to the same cluster if they are based on a shared template, associate each cluster with the shared template, and instructions to identify the sub-plurality of the plurality of deployed instances by identifying the cluster associated with the pre-configured template.

In some examples, computer readable medium 404 includes instructions to determine that the configuration error does not exceed the threshold, and automatically deploy the another instance based on the pre-configured template with the configured resource allocation.

As used herein, a “computer readable medium” may be any electronic, magnetic, optical, or other physical storage apparatus to contain or store information such as executable instructions, data, and the like. For example, any computer readable storage medium described herein may be any of Random Access Memory (RAM), volatile memory, non-volatile memory, flash memory, a storage drive (e.g., a hard drive), a solid state drive, and the like, or a combination thereof. For example, the computer readable medium 404 can include one of or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage containers.

As described herein, various components of the processing system 400 are identified and refer to a combination of hardware and programming to perform a designated visualization function. As illustrated in FIG. 2, the programming may be processor executable instructions stored on tangible computer readable medium 404, and the hardware may include Processor 402 for executing those instructions. Thus, computer readable medium 404 may store program instructions that, when executed by Processor 402, implement the various components of the processing system 400.

Such computer readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Computer readable medium 404 may be any of a number of memory components capable of storing instructions that can be executed by processor 402. Computer readable medium 404 may be non-transitory in the sense that it does not encompass a transitory signal but instead is made up of memory components to store the relevant instructions. Computer readable medium 404 may be implemented in a single device or distributed across devices. Likewise, processor 402 represents any number of processors capable of executing instructions stored by computer readable medium 404. Processor 402 may be integrated in a single device or distributed across devices. Further, computer readable medium 404 may be fully or partially integrated in the same device as processor 402 (as illustrated), or it may be separate but accessible to that device and processor 402. In some examples, computer readable medium 404 may be a machine-readable storage medium.

Examples of the disclosure provide a generalized system for automated configuration of virtual infrastructure. The generalized system provides a protocol for identifying recommended changes in resource utilization of deployed instances, and automatically reconfiguring the configurations of an underlying pre-configured template based on the recommended resource utilizations so as to correctly configure and/or deploy future instances based on the same template.

The system described herein may be extended to Contents, Blue Prints, and/or Service Offerings from other products used for creating virtual assets. For example, with tighter integration of a resource optimizer with automated cloud services, the resource optimizer may establish a correlation between the content for automated cloud services with the assets it is monitoring. Accordingly, the resource optimizer may provide recommendation on the content for automated cloud services.

Although specific examples have been illustrated and described herein, especially as related to numerical data, the examples illustrate applications to any storage container. Accordingly, there may be a variety of alternate and/or equivalent implementations that may be substituted for the specific examples shown and described without departing from the scope of the present disclosure. This application is intended to cover any adaptations or variations of the specific examples discussed herein.

I/We claim:

1. A system, comprising:
at least one processor; and
a memory storing instructions executable by the at least one processor to:
monitor resource utilizations of a plurality of deployed instances in a virtual infrastructure;
receive a request to deploy another instance based on a pre-configured template with a configured resource allocation, the template being common to a sub-plurality of the plurality of deployed instances;
determine a configuration error based on differences between recommended resource utilizations, based on the monitored resource utilizations, of each of the sub-plurality of deployed instances and the configured resource allocation;
determine if the configuration error exceeds a threshold;
upon a determination that the configuration error exceeds the threshold, automatically adjust the configured resource allocation of the template based on the recommended resource utilizations of the sub-plurality of deployed instances; and
deploy the other instance based on the template with the adjusted resource allocation.

2. The system of claim 1, wherein the plurality of deployed instances in the virtual infrastructure comprises a plurality of deployed virtual machines, a plurality of applications deployed on a virtual machine, a plurality of service offerings, or a plurality of blue prints.

3. The system of claim 1, wherein the instructions to determine the configuration error include instructions to determine an average of ratios of the differences between the recommended resource utilizations of each of the deployed instances and the configured resource allocation.

4. The system of claim 1, wherein the average of the ratios is a weighted average of the ratios.

5. The system of claim 1, wherein the configured resource allocation is one of a number of virtual central processing units (vCPUs) assigned to the deployed instances, a size of dynamic memory allocated to the deployed instances, a size for memory at start up time, a minimum memory value, a maximum memory value, a disk space allocation, or a time delay to run an automatic start.

6. The system of claim 1, wherein the instructions to receive the request to deploy another instance include instructions to:
cluster the plurality of deployed instances, wherein two deployed instances belong to the same cluster if they are based on a shared template; and
associate each cluster with the shared template.

7. The system of claim 6, wherein the instructions to receive the request to deploy another instance further include instructions to:
identify the sub-plurality of deployed instances by identifying the cluster associated with the pre-configured template.

8. The system of claim 1, wherein the instructions to automatically adjust the configured resource allocation include instructions to:
determine the configured resource allocation as a weighted average of the recommended resource utilizations of the sub-plurality of deployed instances.

9. The system of claim 1, wherein the instructions to automatically adjust the configured resource allocation include instructions to, upon a determination that the configuration error does not exceed the threshold, automatically determining that the other instance is to be based on the pre-configured template with the configured resource allocation.

10. A method, comprising:
monitoring, via a processor, resource utilizations of a plurality of deployed virtual machines in a datacenter;
clustering, via the processor, the plurality of deployed virtual machines, wherein two virtual machines belong to the same cluster if they share an underlying template;
receiving, via the processor, a request to deploy another virtual machine based on a pre-configured template with a configured resource allocation;
identifying, via the processor, a cluster of virtual machines that are based on the pre-configured template;
determining, via the processor, a configuration error based on differences between recommended resource utilizations, based on the monitored resource utilizations, of each of the sub-plurality of deployed instances and the configured resource allocation;
determining, via the processor, if the configuration error exceeds a threshold;
upon a determination that the configuration error exceeds the threshold, determining, via the processor, the configured resource allocation of the template as an average of the recommended resource utilizations of the deployed virtual machines in the identified cluster; and
deploying, via the processor, the other virtual machine based on the template with the determined resource allocation.

11. The method of claim 10, further comprising determining the configuration error as a weighted average of ratios of the differences between the recommended resource utilizations of each of the deployed instances and the configured resource allocation.

12. The method of claim 10, wherein the configured resource allocation is one of a number of virtual central processing units (vCPUs) assigned to the deployed virtual machines, a size of dynamic memory allocated to the deployed virtual machines; a size for memory at start up time, a minimum memory value, a maximum memory value, a disk space allocation; and a time delay to run an automatic start.

13. The method of claim 10, wherein the average of the recommended resource utilizations of the deployed virtual machines is a weighted average of the recommended resource utilizations.

14. The method of claim 10, wherein the configuration error is based on an average of ratios of the differences between the recommended resource utilizations of each of the deployed virtual machines and the configured resource allocation to the respective recommended resource utilizations.

15. The method of claim 14, wherein the average of the ratios is a weighted average of the ratios.

16. The method of claim 10, further comprising:
upon a determination that the configuration error does not exceed the threshold, automatically deploying the other virtual machine based on the pre-configured template with the configured resource allocation.

17. A non-transitory computer readable medium comprising executable instructions to:
monitor resource utilizations of a plurality of deployed instances in a virtual infrastructure;
receive a request to deploy another instance based on a pre-configured template with a configured resource allocation;
identify a sub-plurality of the plurality of deployed instances that are based on the pre-configured template;
determine a configuration error based on differences between recommended resource utilizations, based on the monitored resource utilizations, of each of the sub-plurality of deployed instances and the configured resource allocation;
determine if the configuration error exceeds a threshold;
upon a determination that the configuration error exceeds the threshold, automatically adjust the configured resource allocation of the template based on the recommended resource utilizations of the sub-plurality of deployed instances; and
automatically configure the configured resource allocation to be the adjusted resource allocation.

18. The computer readable medium of claim 17, wherein the configured resource allocation is one of a number of virtual central processing units (vCPUs) assigned to the deployed instances, a size of dynamic memory allocated to the deployed instances, a size for memory at start up time, a minimum memory value, a maximum memory value, a disk space allocation, or a time delay to run an automatic start.

19. The computer readable medium of claim 17, further comprising instructions to:
cluster the plurality of deployed instances, wherein two deployed instances belong to the same cluster if they are based on a shared template;
associate each cluster with the shared template; and
identify the sub-plurality of the plurality of deployed instances by identifying the cluster associated with the pre-configured template.

20. The computer readable medium of claim 17, further comprising instructions to:
determine that the configuration error does not exceed the threshold; and
automatically deploy the other instance based on the pre-configured template with the configured resource allocation.
